(19) United States
(12) Patent Application Publication
(10) Pub. No.: US 2003/0095113 A1
(43) Pub. Date: May 22, 2003

(54) Index and retrieval system and method for scanned notes from whiteboard

(76) Inventors: Yue Ma, Princeton Junction, NJ (US); Jinhong Katherine Guo, Princeton Junction, NJ (US); Robert S. Fish, Gillette, NJ (US)

Correspondence Address: HARNESS, DICKEY & PIERCE, P.L.C., P.O. BOX 828, BLOOMFIELD HILLS, MI, 48303, US

(21) Appl. No.: 09/990,498

(22) Filed: Nov. 21, 2001

(51) Int. Cl. G09G 5/00

(52) U.S. Cl. 345/175

(57) ABSTRACT

An illustrative demonstration apparatus for use in storing information in a memory is disclosed. The apparatus comprises a reusable panel for temporary display of user-drawn marks, a digitizer for generating digital information corresponding to the user-drawn marks, and an indexer for associating the digital information with a header. The header is based at least in part on a selected portion of the user-drawn marks selected by the user. The apparatus may also feature a redisplay capability permitting redisplay of the user-drawn marks on the reusable panel based on the digital information.

One embodiment of the present invention is a whiteboard with a panel for use with dry-erase markers and a scanner that is adapted to the system and method of the present invention with the addition of a touchscreen display and plotter for reproducing notes on the whiteboard panel. Notes having one or more key regions circled may be scanned and circled region extraction technology utilized to extract a header for indexing the notes that may be recognized text within and/or images of the circled regions, with the circles optionally removed. Headers are displayed on the touchscreen for browsing, and associated notes of a selected header are concurrently displayed. Notes may be printed, plotted, or otherwise further utilized at the user's option and as further supported.

Additional embodiments include implementation with communication and other illustrative demonstration apparatuses having active displays and the ability to accept user drawn marks as input.

### FIELD OF THE INVENTION

The present invention relates generally to index and retrieval systems for use in information processing of user-drawn marks, and more particularly to an index and retrieval system for scanned notes from whiteboard.

### BACKGROUND OF THE INVENTION

Whiteboards are popular collaborative tools widely used in business and technological group endeavors. The ease with which individuals working together on a project can visually communicate ideas to one another using one or more whiteboards has motivated many advances in whiteboard design.

Perhaps foremost among advances in whiteboard design is the ability to save and share whiteboard notes in various ways. For example, some whiteboards with the traditional white panel for use with dry-erase markers employ a scanner for scanning notes into digital form for printing onto hardcopy. Many such whiteboards also have the ability to communicate with a computer for storing notes in memory. Still others use photographic and other techniques, such as radio frequency, to detect user gestures and/or the position of implements (i.e. markers and erasers) for constructing digital information in memory representative of users' markings on the whiteboard. Furthermore, some whiteboards have been developed with active displays in place of the traditional white panel, and users may input markings for display in various ways. One example of such a way involves using a stylus type of marker with a touch sensitive active display to input the markings. Another example of such a way involves implementing position detection technology. In any case, digital information is generally stored in memory and may be shared electronically, printed onto hardcopy, and displayed on an active display at a user's option. In addition, where the whiteboard uses an active display with, for example, a stylus for input, rather than a traditional whiteboard panel with dry erase markers, the notes may be redisplayed so as to allow a discussion to continue where it left off. Retrieving the desired whiteboard note from memory, however, remains problematic.

Some solutions to the problem of retrieving desired whiteboard notes stored in memory have been attempted. When digitized whiteboard notes are in computer memory and a user interface is provided supporting keyboard entry, for example, users have the option of taking the time and making the effort required to descriptively label files containing whiteboard notes in a manner facilitating future retrieval. This first solution, however, is not always available and also requires that users surrender the facility of whiteboard communication while indexing notes. As a second solution, it is also practicable to display plural whiteboard notes in their entirety as a thumbnail on an active display for users to browse, but the information in the notes is difficult to perceive in such a solution. Therefore, providing an ease of use system and method to index whiteboard notes and retrieve them once they are stored in a system remains the task of the present invention.

### SUMMARY OF THE INVENTION

In a first aspect, the present invention is an illustrative demonstration apparatus for use in storing information in a memory. The apparatus comprises a reusable panel for temporary display of user-drawn marks, a digitizer for generating digital information corresponding to the user-drawn marks, and an indexer for associating the digital information with a header. The header is based at least in part on a selected portion of the user-drawn marks selected by the user.

In a second aspect, the present invention is an indexing method for use with an index and retrieval system for scanned notes from whiteboard. The method comprises the steps of extracting a selected portion of user-drawn marks, wherein the selected portion is selected by a user, constructing a header based at least in part on the selected portion, and associating digital information as data with the header as metadata. The digital information is generated at least in part from the user-drawn marks.

In a third aspect, the present invention is a retrieval method for use with an index and retrieval system. The method comprises the steps of displaying index information associated with metadata, wherein the metadata indexes data corresponding to digital information generated from user-drawn marks, and wherein the metadata corresponds to a header based at least in part on a selected portion of the user-drawn marks, and displaying the user-drawn marks in response to user-selection of the index information.

In a fourth aspect, the present invention is a whiteboard apparatus. The apparatus comprises a reusable panel for visual display of whiteboard notes, upon which whiteboard notes are written with whiteboard pens dispensing erasable ink, and a plotter for plotting machine-drawn marks onto said reusable panel using at least one whiteboard pen dispensing erasable ink, wherein the whiteboard notes are plotted based on digital information stored in memory, and wherein said digital information corresponds to user-drawn marks.

In a fifth aspect, the present invention is a mark-up removal method for use with an index and retrieval system. The method comprises the steps of moving a scan line in a plane of an image in a first direction, scanning the marked-up region in a second direction, wherein the second direction lies perpendicular to the first direction in the plane of the image, detecting non-background pixels within the scan line corresponding to mark-up of the image, and erasing the non-background pixels.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a is a perspective view of a first whiteboard apparatus according to the previous technology featuring a scrolling panel and a fixed scanner.

FIG. 1b is a perspective view of a second whiteboard apparatus according to the previous technology featuring a fixed panel and a mobile scanner.

FIG. 2 is a perspective view of a whiteboard apparatus in communication with a personal computer, wherein flow of digitized information corresponding to whiteboard notes having a circled region is depicted, and wherein circled region extraction, circle removal, and handwriting recognition are supported.

FIG. 3 is a flowchart depicting a method for indexing notes scanned from whiteboard in accordance with the present invention.

FIG. 4 is a representative view of a scan line for use with mark-up removal shown in the process of detecting non-background pixels that correspond to portions of a user-drawn circle.

FIG. 5a is a representative browser screen depicting whiteboard notes indexed by headers corresponding to extracted circled regions of the notes with circles removed.

FIG. 5b is a representative browser screen depicting whiteboard notes indexed by headers corresponding to recognized text from within a circled region of the associated notes.

FIG. 6 is a perspective view of a whiteboard apparatus with a plotter and touch screen display in accordance with the present invention.

FIG. 7 is a flowchart depicting circle extraction according to the system and method of the present invention.

### DETAILED DESCRIPTION OF THE PREFERRED EMBODIMENTS

The following description of the preferred embodiment(s) is merely exemplary in nature and is in no way intended to limit the invention, its application, or uses.

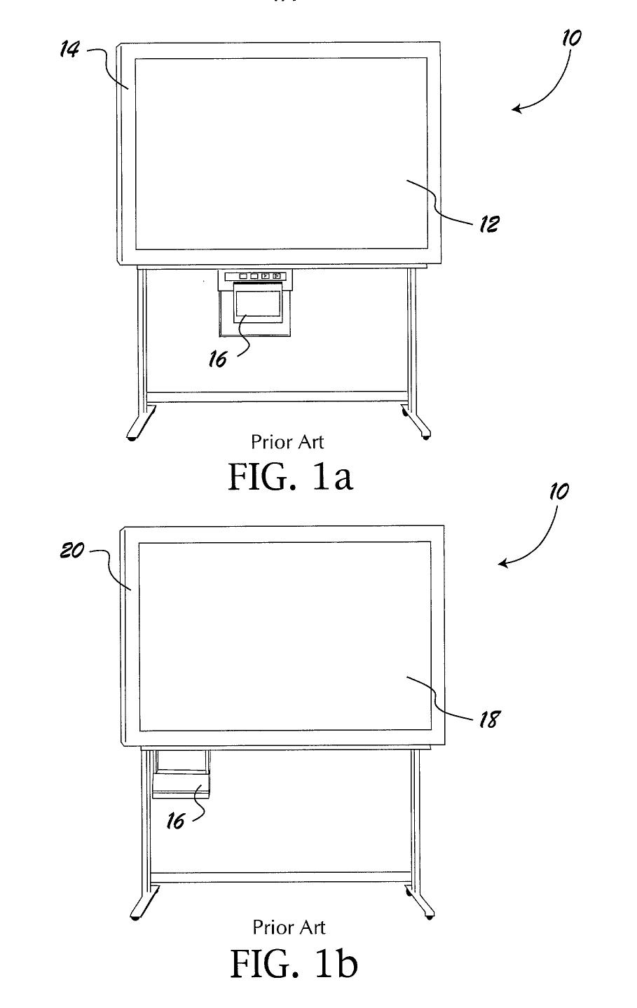

Referring to FIG. 1a, a whiteboard apparatus 10 according to the previous technology is shown that features a scrolling panel 12 and a fixed scanner (not shown) hidden in the frame 14. The scrolling panel 12 may feature two or four writing surfaces each accessible in turn by scrolling the panel in a horizontal direction. The whiteboard apparatus also features a printer 16 for printing scanned notes onto hardcopy. Users may mark on the scrolling panel 12 with standard dry erase markers and erase with an eraser, tissue, fingertips, or other means as needed. Users may then print the finished whiteboard notes by activating a scanning mode wherein the scrolling panel 12 scrolls in a horizontal direction and the fixed scanner (not shown) hidden in the frame 14 generates digital information corresponding to the whiteboard notes that is simultaneously printed on hardcopy via the printer 16. Several copies may be printed at the users' option, but following printing the digital information is lost unless communicated to a computer memory (not shown) via a communications link (not shown). Many state of the art whiteboards of the type shown in FIG. 1 feature a communications link (not shown) for this purpose.

The whiteboard apparatus 10 of FIG. 1 is displayed here for reference because the following exemplary embodiments will primarily be discussed with regard to utilization, incorporation, adaptation, and combinations thereof the whiteboard apparatus 10 of FIG. 1. The whiteboard apparatus of FIG. 1, while lacking some of the advantages associated with implementing a large active display and/or simultaneous generation of digital information, does not incorporate the expense associated with a large active display and features the greatest ease of use by avoiding the need for special implements, which may be lost, and/or requirements for users to change illustration modes (i.e. color and/or write mode vs. erase mode) and possibly lose information due to delay or mismatch between activated mode and actual marks on the screen. One skilled in the art, however, will recognize that the system and method of the present invention will find application with other implementations of the whiteboard apparatus 10, as well as with personal digital assistants, laptops with touchscreens, cell phones, and other illustrative demonstration tools useful for collaboration through various means, including but not limited to digital data link.

Referring to FIG. 1b, a whiteboard apparatus 10 is shown that features a static panel 18 and a mobile scanner 20. The static panel 18 is static in the sense that it does not move during scanning, but remains in place while the mobile scanner 20 moves horizontally across the static panel 18. The static panel 18, however, may flip over to reveal a second writing surface. The whiteboard apparatus 10 also features a printer 16 and is in other respects similar to the whiteboard apparatus of FIG. 1a. The whiteboard apparatus of FIG. 1b is displayed for reference to demonstrate that various means exist for scanning or otherwise acquiring notes from whiteboard that are known in the art and that adaptation of the present invention to accommodate these various means will be obvious to those skilled in the art.

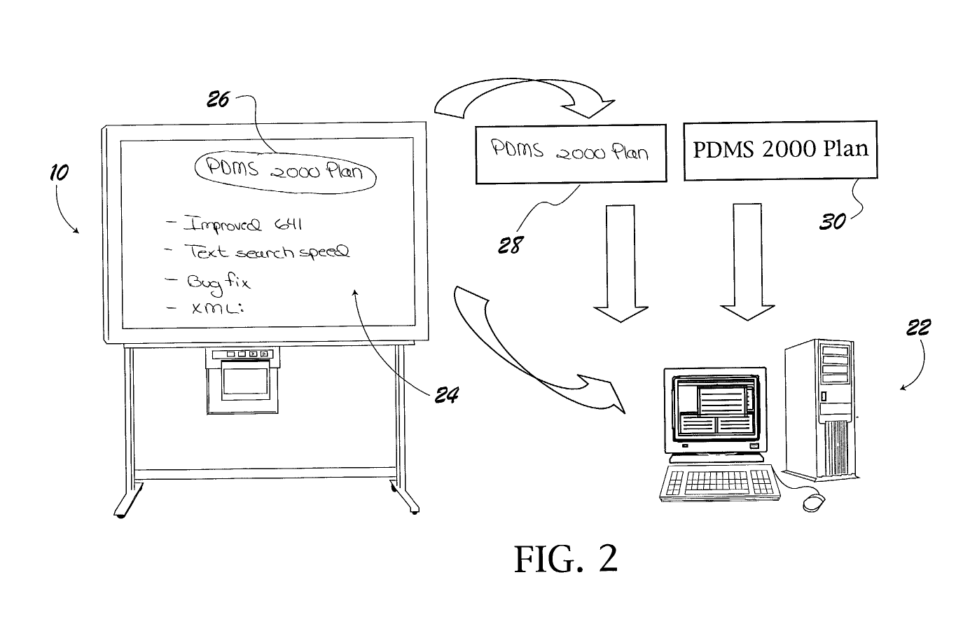

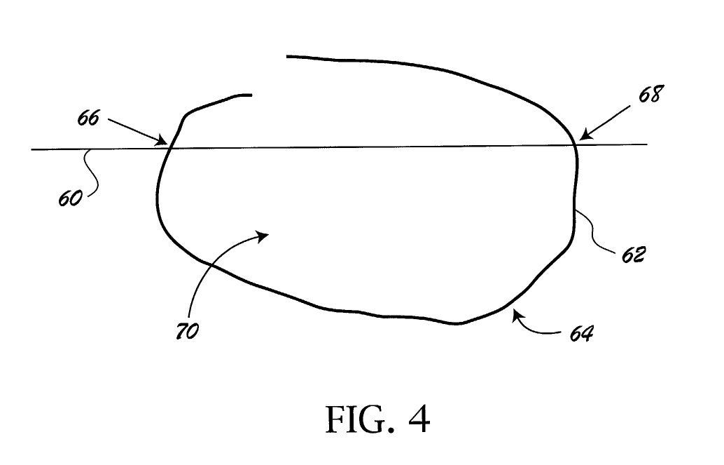

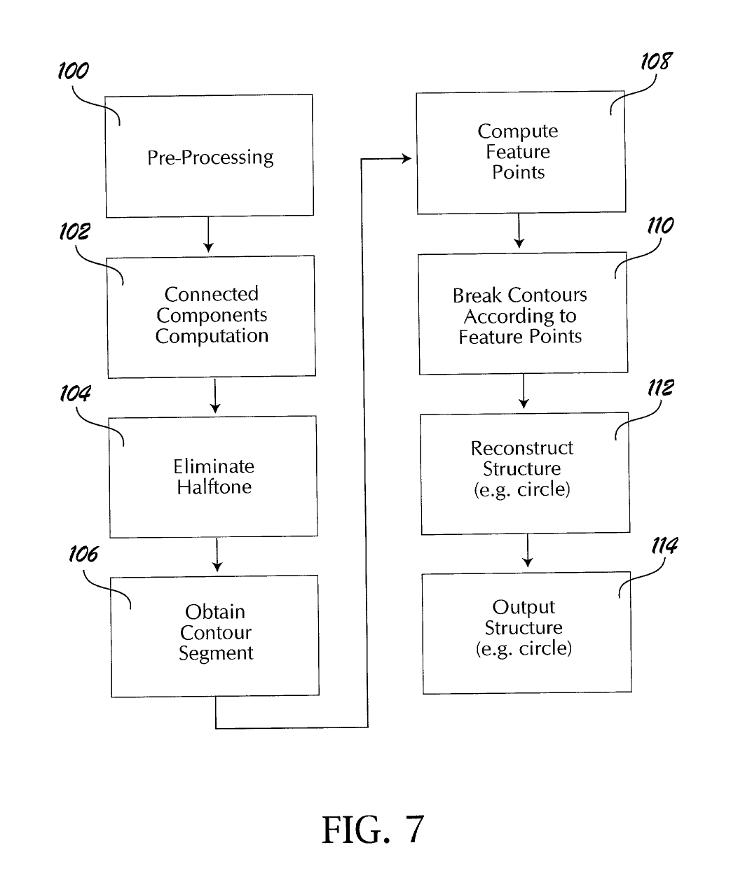

Referring to FIG. 2, a whiteboard apparatus 10 is shown in communication with a personal computer 22. Additionally, the whiteboard apparatus 10 is depicted as displaying user-drawn marks on the scrolling panel corresponding to whiteboard notes 24 having a marked-up region corresponding to a circled region 26 that is a key region of the whiteboard notes 24. As according to the present invention, the circled region 26 is extracted from the digital information generated by the scanner (not shown) via circled region extraction technology. As will be appreciated by those skilled in the art, circled region extraction technology may be applied to digital information corresponding to scanned notes from whiteboard; circled region extraction technology is explained below with reference to FIG. 7. As further according to the present invention, optional mark-up removal corresponding to circle removal is applied to the extracted digital information to generate an extracted circled region 28. Circle removal is more fully detailed below with reference to FIG. 4.

Still further in accordance with the present invention, optional handwriting recognition technology is applied to the extracted circled region 28 to generated recognized text 30 corresponding to handwritten text within the circled region 26. As will be obvious to those skilled in the art, each step in the system and method of the present invention disclosed thus far involving circled region extraction, circle removal, and handwriting recognition may be accomplished at any time or location subsequent to and/or simultaneous with generation, communication, and/or receipt of digital information corresponding to the whiteboard notes 24. For example, if the whiteboard apparatus 10 has the necessary computing capability, any of the three steps may be accomplished “on-board” the whiteboard apparatus 10. Additionally, any of the three steps may be accomplished on the personal computer 22 after and/or simultaneous with receipt of the information or en route at any of a plurality of optional intervening computing modules (not shown). One skilled in the art will recognize that further possibilities exist regarding the order, location, combinations, and/or manner in which the steps take place.

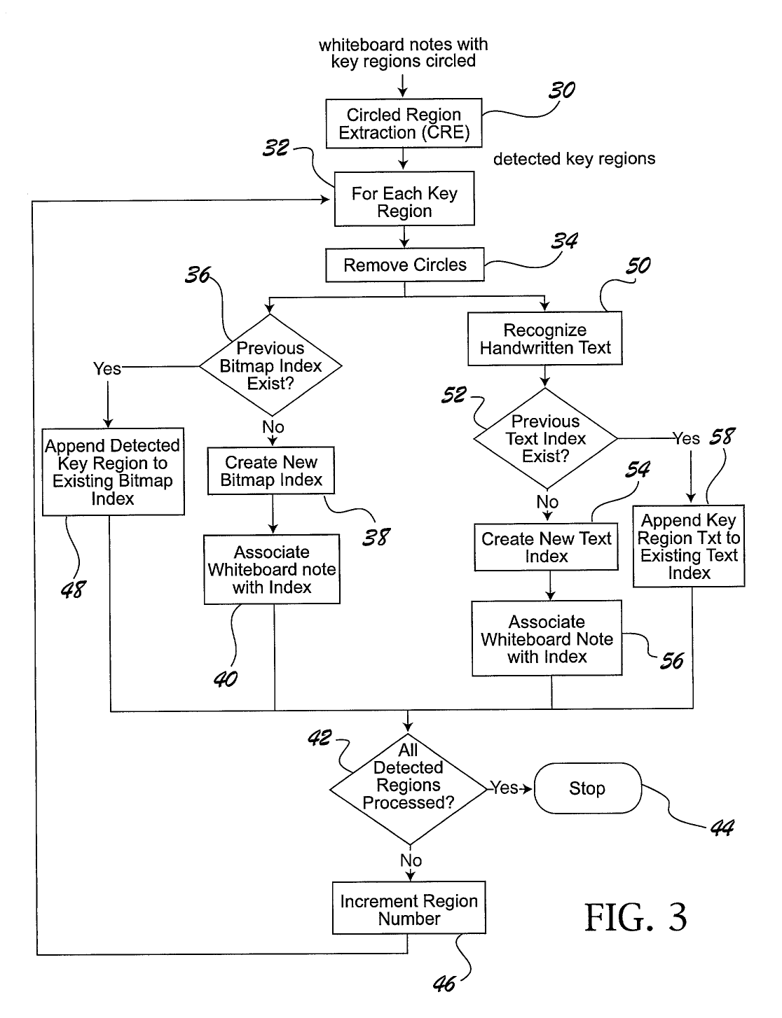

Referring to FIG. 3, an indexing method according to the present invention is shown. The method supports optional circle removal and handwriting recognition for purposes of illustration. As according to FIG. 3, circled region extraction is performed on digital information corresponding to whiteboard notes with key regions circled at step 30. As a result of processing at step 30, digital information corresponding to a plurality of detected key regions is produced such that every circled region is extracted from the whiteboard notes. Processing of each key region begins at step 32, and optional circle removal is performed on each key region.

Circle removal assists the system and method of the present invention in two ways. First, in the event that index images corresponding to thumbnails of an extracted circled region are presented for user selection, circle removal assists in users' viewing of the index images. Second, in the event that index images corresponding to recognized text from within extracted circled regions are presented for user selection, circle removal assists in handwriting recognition of text within the extracted circled region. An exemplary method for circle removal will be more fully detailed below.

Subsequent to optional circle removal at step 34, either or both of two courses may be taken. These two courses are further detailed below.

In the first course, a determination is made whether a previous bitmap index exists for the whiteboard notes as at 36. In the event that no previous bitmap index exists for the whiteboard notes (i.e. this key region is the first key region processed for these whiteboard notes) a new bitmap index is created at step 38 and the whiteboard notes are associated as data with the bitmap index as metadata at step 40.

Following association of the data with the metadata, a determination is made regarding whether all detected key regions have been processed as at 42, and processing stops as at 44 if all detected key regions have been processed. If all detected key regions have not been processed, a region number is incremented at step 46 and processing continues at step 32. Circle removal is optionally performed on the next key region at step 34, and when the determination is made as at 36 regarding whether a previous bitmap index exists for these whiteboard notes, the determination will be in the affirmative since the bitmap index was created previously as noted above. Thus, the detected key region is appended to the existing bitmap index at step 48. In other words, a second header is constructed for the second key region and the whiteboard notes are associated with the second header.

Following appending of the detected key region to the existing bitmap index, processing continues with a determination being made whether all detected key regions have been processed and, if so, processing stops as at 44. If there exist additional detected key regions that have not been processed, processing continues with each key region being appended to the existing bitmap index as at step 48. The result of this processing is indexing of data with metadata, wherein the data is digital information corresponding to whiteboard notes having circled key regions, and wherein the metadata is a bitmap index corresponding to the plurality of detected key regions with each detected key region processed after the first detected key region being appended to the preceding key region. In other words, headers are constructed for the each key region and the whiteboard notes are associated with each header.

In the second course, handwriting recognition is performed on a detected key region at step 50, and recognized text is generated corresponding to the user-drawn text within the detected key region. A determination is made whether a previous text index exists for the whiteboard notes as at 52. In the event that no previous text index exists for the whiteboard notes (i.e. this key region is the first key region processed for these whiteboard notes) a new text index is created at step 54 that corresponds to the recognized text and the whiteboard notes are associated as data with the text index as metadata at step 56.

Following association of the data with the metadata, a determination is made regarding whether all detected key regions have been processed as at 42, and processing stops as at 44 if all detected key regions have been processed. If all detected key regions have not been processed, a region number is incremented at step 46 and processing continues at step 32. Circle removal is optionally performed on the next key region at step 34, and handwriting recognition is performed on the detected key region at step 50 to generate recognized text corresponding to the user-drawn text within the detected key region. When the determination is made as at 52 regarding whether a previous text index exists for these whiteboard notes, the determination will be in the affirmative since the text index was created previously as noted above. Thus, the recognized text is appended to the existing text index at step 58. In other words, a second header is constructed for the second key region and the whiteboard notes are associated with the second header.

Following appending of the recognized text to the existing text index, processing continues with a determination being made whether all detected key regions have been processed and, if so, processing stops as at 44. If there exist additional detected key regions that have not been processed, processing continues with each recognized text from each key region being appended to the existing text index as at step 58. The result of this processing is indexing of data with metadata, wherein the data is digital information corresponding to whiteboard notes having circled key regions, and wherein the metadata is a text index with appended text. The text index corresponds to the recognized text from within the detected key region that is first processed, and the appended text corresponds to recognized text from within each detected key region processed subsequent to the detected key region that is first processed, wherein the recognized text from within each detected key region that is not the first processed is appended to the recognized text from within the preceding detected key region. In other words, headers are constructed for the each key region and the whiteboard notes are associated with each header.

As will be readily understood by one skilled in the art, processing consistent with the indexing method according to the present invention may take many forms. For example, circle removal may or may not be implemented, processing may not include all detected key regions, either or both types of indexed data may be generated either simultaneously or in any order, and more or less steps may be implemented in various orders and/or combinations. Additionally, more details regarding an exemplary mark-up removal method according to the present invention are set forth below.

Referring to FIG. 4, a scan line 60 for use with mark-up removal is shown in the process of detecting non-background pixels 62 that correspond to portions of a user-drawn circle 64. In an exemplary mark-up removal method, the scan line 60 moves from the top of the circled region to the bottom of the circled region at a step of one pixel. For each scan, the non-background pixel 62 that is on the far left is marked with “xmin” as shown at 66. Similarly, the non-background pixel 62 that is on the far right is marked with “xmax” as shown at 68. At the same scan line 60, movement is made from “xmin” to the right until a first background pixel 70 is detected, and all non-background pixels 62 are erased in movement to the left from the current position to and including “xmin.” Similarly, at the same scan line 60 movement is made from “xmax” to the left until a first background pixel 70 is detected, and all non-background pixels 62 are erased in movement to the right from the current position to and including “xmax.” Those skilled in the art will readily appreciate that, though designed to be simple, the exemplary mark-up removal method may be altered in several ways in accord with the present invention.

As a result of tailoring to perform circle removal on circled regions extracted from scanned notes from whiteboard, the exemplary mark-up removal method makes certain assumptions. For example, it assumes that there is only one user-drawn circle 64 in each detected key region. It also assumes that the user-drawn circle 64 is roughly a concave curve. It further assumes that the image area of the circled region is clean after pre-processing. It still further assumes that the user-drawn circle 64 can be closed or near closed. One skilled in the art will readily understand that various alterations in the method disclosed above can be made that are consistent with the present invention. For example, scanning may occur from bottom to top, side to side, radially, in one or multiple portions of a marked-up area, or in other ways appropriate to and facilitated by the type of mark-up and digital image processing employed. Similarly, marking of background pixels 70 may occur rather than marking of non-background pixels 62, with erasure of background pixels 62 proceeding in various directions to and from various points. Further, different types of mark-up, including user-drawn lines and/or curves comprising brackets, parentheses, boxes, underlines, etc., may be removed using the mark-up removal method of the present invention if different and/or additional assumptions are accommodated as will be readily understood by one skilled in the art. Additionally, an exemplary implementation of a retrieval system and method utilizing the indexed data resulting from the previously disclosed system and methods is disclosed below.

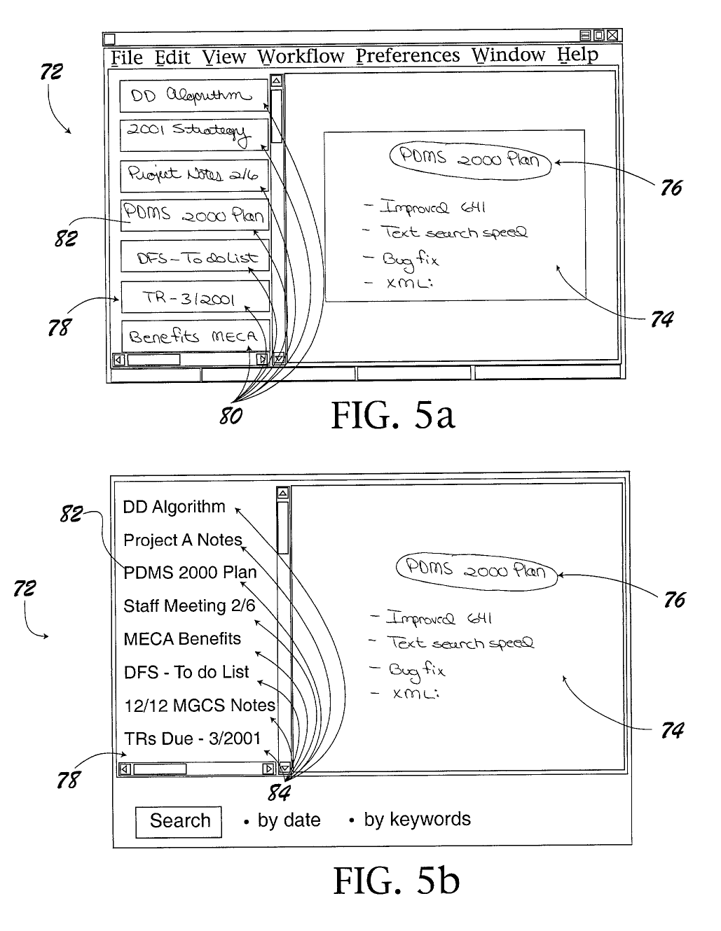

Referring to FIG. 5a, a browser screen 72 is shown depicting whiteboard notes 74 having circled regions 76 indexed by index information 78 corresponding to user-drawn marks from extracted circled regions 80 of the associated whiteboard notes 74 with circles removed. A user may, thus, browse thumbnail headers of stored whiteboard notes 74 and, upon user selection of a particular header, the whiteboard notes associated with the selected header 82 may be concurrently displayed. The user may then choose to take additional action concerning the whiteboard notes 74, such as printing, faxing, emailing, editing, and/or redisplaying the notes on the whiteboard apparatus when such additional actions are supported in conjunction with the apparatus displaying the browser screen 72.

Referring to FIG. 5b, a browser screen 72 is shown depicting whiteboard notes 74 having circled regions 76 that are indexed by index information 78 corresponding to recognized text 84 from within the extracted circled regions (not shown) of the associated whiteboard notes 74. Similarly to the method and system of retrieval disclosed above with respect to FIG. 5a, a user may browse text headers of stored whiteboard notes 74 and, upon user selection of a particular header, the whiteboard notes associated with the selected header 82 may be concurrently displayed and further action optionally taken as supported.

One skilled in the art will readily understand that it may be desirable to implement circle removal, text recognition, and generation of both bitmap and text index metadata types to facilitate ease of use. Users may benefit from the ability to switch back and forth between index images corresponding to extracted circled regions and recognized text to facilitate browsing. For example, the bitmap-based header may prove superior where a particular user's ability to interpret the user-drawn marks of a particular set of whiteboard notes exceeds that of the handwriting recognition technology employed. Similarly, the text-based header may prove superior where the ability of the handwriting recognition technology to interpret the user-drawn marks of a particular set of whiteboard notes 74 exceeds that of a particular user. Additionally, an exemplary apparatus for implementation of the system and method of the present invention is more detailed below.

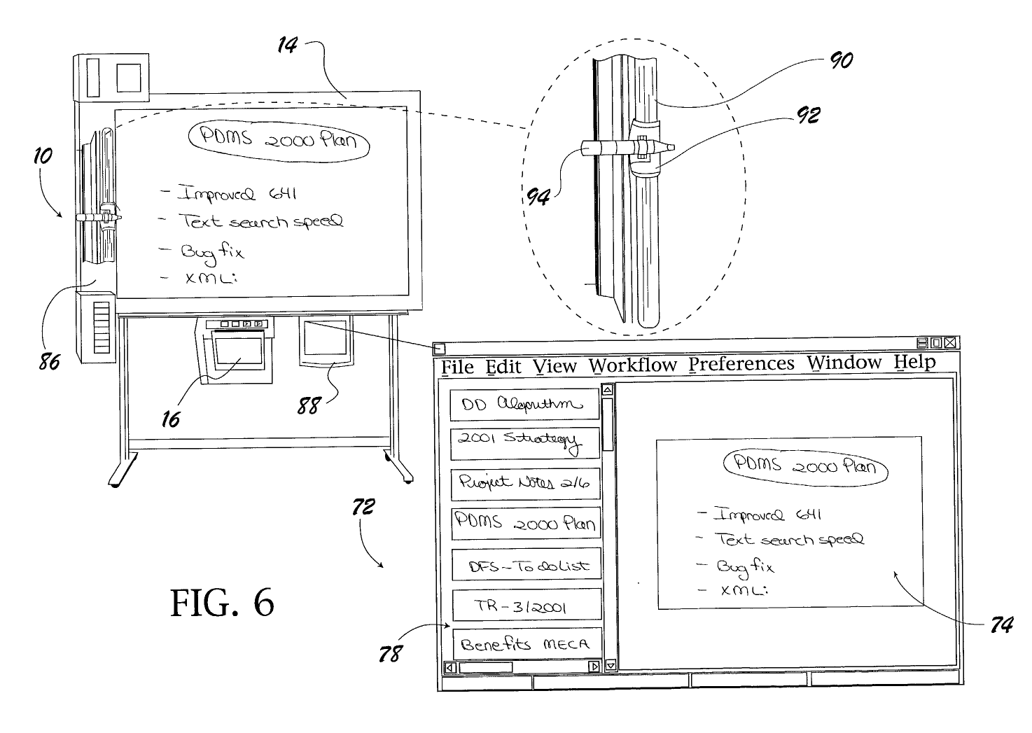

Referring to FIG. 6, a whiteboard apparatus 10 with a plotter 86 and touchscreen display 88 for use with the system and method of the present invention is shown. The whiteboard apparatus 10 of FIG. 6 is similar to the whiteboard apparatus 10 of FIG. 1a, but has been adapted for use with the present invention. The touchscreen display 88 is shown as mounted at the bottom of the frame 14 of the whiteboard apparatus 10 adjacent to the printer 16 and tilted upward so as to be viewable to and operable by a user standing before the whiteboard apparatus 10. It may be desirable to hinge the touchscreen display 88 so as to permit user manipulation, to place the touchscreen display 88 in another location, and/or to make the touchscreen display 88 detachable so as to facilitate remote control of the whiteboard apparatus 10. An exemplary browser screen 72 is shown displayed on the touchscreen display 88 enabling user selection of headers 78 by touch operation of the touchscreen display 88.

Once a user has selected a particular set of whiteboard notes 74, the user may print the notes to hardcopy via the printer 16, and/or redisplay the notes via the plotter 86, shown vertically mounted on and/or incorporated into the frame 14. It is also foreseeable that users may email, fax, edit, or otherwise take further action regarding the whiteboard notes 74 as supported by the whiteboard apparatus or a second device (not shown) in communication with the whiteboard apparatus via a communications link (not shown).

The exemplary plotter 86, features a fixed arm 90 with a vertically mobile sleeve 92 for manipulating a plotter pen, such as a dry-erase marker 94. The exemplary plotter 86, operates by moving the dry erase marker 94 vertically in relation to the horizontally scrolling panel 12 while intermittently bringing the writing tip of the dry erase marker 94 into contact with the scrolling panel 12 to reproduce the selected whiteboard notes 74 from memory.

As will readily be understood by one skilled in the art, various types of plotters 86 and plotter mounting schemes may be implemented to accomplish the present invention. For example, the whiteboard apparatus 10 of FIG. 1b may have a horizontally mobile arm with a vertically mobile sleeve, while both examples of the whiteboard apparatus 10 may implement one or more arms mobile in multiple linear and/or radial directions. Additionally, plotters may have multiple markers, markers capable of switching color, and/or the ability to change markers during use. Additional implementations will be readily understood by one skilled in the art. Finally, it will be readily apparent to one skilled in the art that whiteboards, laptops, personal computers, personal digital assistants, cell phones, and similar communication tools having active displays for the main display with touchscreen and/or similar input means for accepting user-drawn marks have inherent redisplay capability and thus may reproduce user-drawn marks without the need for a plotter. Application of the system and method of the present invention to the aforementioned technologies will be readily appreciated by those skilled in the art, as will advantages associated with such application.

Referring to FIG. 7, a flowchart depicting a procedure identifying a user-drawn circle in a scanned image for use with the present invention is shown. Beginning at step 100, the procedure first pre-processes the image to convert the image data into suitable resolution and bit depth for connected component analysis. This preprocessing is an optional step that can be performed, for example, to convert color image data into black-and-white data or to convert gray scale data into black and white data.

The procedure next proceeds to step 102 where connected component analysis is performed. A first embodiment uses pixel labeling with bounding box computation techniques to extract candidate objects for performing connected component analysis, whereas a second embodiment uses run-length analysis techniques. According to the first embodiment, the image is scanned line-by line and each pixel is labeled if it is connected with its neighboring pixels. After labeling the pixels for connectivity, a bounding box is calculated for each connected component. These bounding boxes are used to extract the candidate area in the image. According to the second embodiment, the image data is expressed as a grid of columns and rows and a scan order is established over the grid to define parent, child, and sibling relationships among run lengths of contiguous or nearly contiguous black pixels according to mutual proximity and position within the grid. These relationships, along with starting and ending column and row positions for a run, are populated into one or more run data structures which may be traversed to identify contours within a region.

If desired, at step 104, half-tone data may be eliminated and small gaps in pixel data (attributable to noise) may be eliminated. Individual white pixels in an otherwise black pixel domain may be converted to black pixels to “fill in” or de-speckle the image data. Also, contours unlikely to represent a user-drawn circle may be eliminated based on predetermined criteria, such as in the case where a bounding box of the first embodiment is too small.

After the connected components have been identified, the process advances to step 106, where contour segment information is extracted from the data. The contour segment extraction process is performed according to the first embodiment by tracing the inside and outside perimeters of the lines that define the candidate objects. According to the second embodiment, the contour segment extraction process is performed using the populated data structures formed during run length analysis as disclosed above. More specifically, traversal of the populated data structure among midpoints of run lengths from parent to child, then sibling to sibling, then child to parent, for example, in a recursive manner permits recognition of connected contours readily corresponding to vector graphics, for example. In the case of either the first or second embodiment, the contour segment extraction process results in one or more connected contours, where a connected contour serves as a “replacement” for the originally drawn circle.

Following extraction of contour segments, the procedure continues by computing feature points in a connected contour at step 108. In one embodiment, maximum and/or minimum x and y values of a connected contour serve as feature points, as do any endpoints of the connected contour and/or junctions of circles with other objects. These feature points are used to break the connected contour into contour segments at step 110. Breaking the connected contour according to its feature points is useful in situations where user-drawn circles may contact or overlap other contour structures.

Following breaking of connected contours according to feature points, the feature points are then used at step 112 to reconstruct circles In essence, segments are examined and reconnected such that segments belonging to different objects are separated and those belonging to the same object are connected. The main criterion for reconnecting the contour segments is to check the smoothness when making the transition between neighboring segments. A predetermined threshold regarding comparative slope of a constructed line between proximate endpoints of two segments, for example, may be used to determine whether two line segments are approaching one another in such a way as to be connected. Other approaches for analyzing the angle between proximate segments will also be obvious to those skilled in the art.

Following reconnection of segment endpoints, reconstructed circles are then output at step 114. The reconstructed circles are generated without gaps or ambiguity regarding closure, thus the subsequent image processing can be performed more efficiently.

As will be readily appreciated by one skilled in the art, it may be additionally desirable to analyze any open loops to ensure that endpoints of a contour are constrained within a predetermined distance of one another and/or another enclosing portion of the circle as part of or in addition to the steps detailed above. As a result of the generation of unambiguous, reconstructed circles as detailed above, a bounding box around the contour of the generated circle may be used to delimit the area for extraction. Similarly, one may choose a bounding oval, etc.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An illustrative demonstration apparatus for use in storing information in a memory, the apparatus comprising:
a reusable panel for temporary display of user-drawn marks;
a digitizer for generating digital information corresponding to the user-drawn marks; and
an indexer for associating the digital information with a header,
wherein the header is based at least in part on a selected portion of the user-drawn marks selected by the user.

2. The apparatus of claim 1, wherein the reusable panel corresponds to a whiteboard panel for use with temporary markers dispensing erasable ink.

3. The apparatus of claim 2, wherein the digitizer corresponds to a scanner for scanning whiteboard notes from the whiteboard panel.

4. The apparatus of claim 3, wherein the selected portion of the user-drawn marks corresponds to a circled region of the whiteboard notes.

5. The apparatus of claim 4, wherein the indexer uses an indexing method, the method comprising:
extracting a circled region of the whiteboard notes using circled region extraction;
constructing a header based at least in part on the circled region; and
associating the digital information as data with the header as metadata.

6. The apparatus of claim 5, wherein the user-drawn marks contain plural circled regions, wherein every circled region is extracted, wherein headers are constructed for each circled region, and wherein the digital information is associated as data with each header as metadata.

7. The apparatus of claim 5, wherein the indexing method further comprises the step of removing a circle from the circled region, and wherein the header is based at least in part on the circled region from which the circle has been removed.

8. The apparatus of claim 7, wherein the indexing method further comprises the step of constructing recognized text using handwriting recognition on the circled region from which the circle has been removed, and wherein the header is based at least in part on the recognized text.

9. The apparatus of claim 1, wherein said reusable panel has a redisplay capability permitting redisplay of the user-drawn marks on the reusable panel based on the digital information.

10. The apparatus of claim 9, wherein the redisplay capability stems from a plotter operably coupled to said reusable panel.

11. The apparatus of claim 9, further comprising an active display for display of a plurality of headers, wherein associated digital information that is digital information associated with a header is concurrently displayed on said active display with the header upon selection of the header by a user.

12. The apparatus of claim 11, wherein the associated digital information is displayed on the reusable panel via the redisplay capability as machine-drawn marks at an option of the user, and wherein the machine drawn marks resemble the user-drawn marks from which the associated digital information was generated.

13. The apparatus of claim 7, wherein the step of removing the circle from the circled region employs a circle removal method, the method comprising:
moving a scan line in a plane of the circle region in a first direction;
scanning the circled region in a second direction, wherein the second direction lies in a complementary fashion to the first direction in the plane of the circled region;
detecting non-background pixels within the scan line corresponding to the circle; and
erasing the non-background pixels.

14. The apparatus of claim 13, wherein the circle removal method further comprises:
detecting a first non-background pixel within the scan line, wherein the first non-background pixel corresponds to the non-background pixel first detected in a first linear scan of all pixels in the scan line;
detecting a first background pixel within the scan line, wherein the first background pixel corresponds to the background pixel first detected after detection of the first non-background pixel in the first linear scan of all pixels in the scan line;
detecting a second non-background pixel within the scan line, wherein the second non-background pixel corresponds to the non-background pixel last detected in the first linear scan of all pixels in the scan line;
detecting a second background pixel within the scan line, wherein the second background pixel corresponds to the background pixel first detected in a second linear scan of pixels in the scan line, wherein the second linear scan starts at the second non-background pixel and proceeds in a direction opposite to the first linear scan;
removing the first non-background pixel;
removing all non-background pixels between the first non-background pixel and the first background pixel;
removing the second non-background pixel; and
removing all non-background pixels between the second non-background pixel and the second background pixel.

15. The system of claim 14, wherein there exists only one circle in each circled region, wherein the circle is a concave curve that is at least one of closed and near closed, and wherein speckle noise has been removed from the circled region via preprocessing.

16. An indexing method for use with an index and retrieval system for scanned notes from whiteboard, the method comprising:
extracting a selected portion of user-drawn marks, wherein the selected portion is selected by a user;
constructing a header based at least in part on the selected portion; and
associating digital information as data with the header as metadata,
wherein the digital information is generated at least in part from the user-drawn marks.

17. The method of claim 16, wherein the user-drawn marks contain plural selected portions, wherein headers are constructed based at least in part on each selected portion, and wherein the digital information is associated as data with each header as metadata.

18. The method of claim 16, wherein the selected portion of the user-drawn marks corresponds to a marked-up region, wherein the indexing method further comprises the step of removing mark-up from the marked-up region, and wherein the header is based at least in part on the marked-up region from which mark-up has been removed.

19. The method of claim 18, the method further comprising the step of constructing recognized text using handwriting recognition on the marked-up region from which the mark-up has been removed, and wherein the header is based at least in part on the recognized text.

20. A retrieval method for use with an index and retrieval system, the method comprising:
displaying index information associated with metadata, wherein the metadata indexes data corresponding to digital information generated from user-drawn marks, and wherein the metadata corresponds to a header based at least in part on a selected portion of the user-drawn marks; and
displaying the user-drawn marks in response to user-selection of the index information.

21. The method of claim 20, wherein the user-drawn marks correspond to whiteboard notes, wherein the selected portion corresponds to a circled region, wherein the index information is a header corresponding to at least one of an image of the circled region and recognized text from within the circled region, and wherein the whiteboard notes associated with the header are concurrently displayed on the active display when the header is selected.

22. A whiteboard apparatus, the apparatus comprising:
a reusable panel for visual display of whiteboard notes, upon which whiteboard notes are written with whiteboard pens dispensing erasable ink; and
a plotter for plotting machine-drawn marks onto said reusable panel using at least one whiteboard pen dispensing erasable ink, wherein the whiteboard notes are plotted based on digital information stored in memory, and wherein said digital information corresponds to user-drawn marks.

23. A mark-up removal method for use with an index and retrieval system, the method comprising:
moving a scan line in a plane of an image in a first direction;
scanning the marked-up region in a second direction, wherein the second direction lies in a complementary fashion to the first direction in the plane of the image;
detecting non-background pixels within the scan line corresponding to mark-up of the image; and
erasing the non-background pixels.

24. The method of claim 23, method further comprising:
detecting a first non-background pixel within the scan line, wherein the first non-background pixel corresponds to the non-background pixel first detected in a first linear scan of all pixels in the scan line;
detecting a first background pixel within the scan line, wherein the first background pixel corresponds to the background pixel first detected after detection of the first non-background pixel in the first linear scan of all pixels in the scan line;
detecting a second non-background pixel within the scan line, wherein the second non-background pixel corresponds to the non-background pixel last detected in the first linear scan of all pixels in the scan line;
detecting a second background pixel within the scan line, wherein the second background pixel corresponds to the background pixel first detected in a second linear scan of pixels in the scan line, wherein the second linear scan starts at the second non-background pixel and proceeds in a direction opposite to the first linear scan;
removing the first non-background pixel;
removing all non-background pixels between the first non-background pixel and the first background pixel;
removing the second non-background pixel; and
removing all non-background pixels between the second non-background pixel and the second background pixel.

25. The method of claim 23, wherein the mark-up is a user drawn circle, wherein there exists only one circle in each marked-up region, wherein the user drawn circle is a concave curve that is at least one of closed and near closed, and wherein speckle noise has been removed from the marked-up region via preprocessing.
